(19) United States
(12) Patent Application Publication
(10) Pub. No.: US 2002/0172478 A1
(43) Pub. Date: Nov. 21, 2002

(54) Light transmission techniques

(76) Inventor: Jennifer Joyce Sahlin, Minneapolis, MN (US)

Correspondence Address: SHUMAKER & SIEFFERT, P. A., 8425 SEASONS PARKWAY, SUITE 105, ST. PAUL, MN, 55125, US

(21) Appl. No.: 09/862,164

(22) Filed: May 21, 2001

(51) Int. Cl. G02B 6/04

(52) U.S. Cl. 385/115; 385/147; 385/901

(57) ABSTRACT

The invention is directed to techniques for bundling multiple light guides and various apparatuses and systems for implementing the techniques. For example, the cross sectional shape of multiple light guides can be modified at first ends of the guides. The first ends can be placed in intimate contact to define a bundle. In this manner, the amount of light that enters the guides can be increased, resulting in a more efficient use of light. In addition, by removing the cladding from the light guides in the location where the respective guides are bundled, light is allowed to distribute between the multiple light guides as light transmits down the initial portion of the bundle. In this manner, light can be more readily homogenized.

The invention relates to light guides for functional or decorative lighting, and, more particularly, to bundled light guides.

### BACKGROUND

Light guides generally include a core material having a relatively high refractive index and an outer cladding material having a relatively low refractive index. A light source can be used to illuminate one or more light guides such that light is transmitted through the guides via internal reflectance. Light guides may provide side lighting, in which light is emitted along the sides of the guides. In addition, light guides may provide end lighting, in which light is emitted from the end of the guides.

Light guides can be used to provide functional or decorative lighting. Functional lighting refers to lighting that is used for the purpose of illuminating an object or area so that individuals can see that object or area. Decorative lighting refers to lighting that is used for aesthetic purposes. Often, light guides are used for both decorative and functional purposes.

Lighting systems that implement light guides generally have a light source, such as a lamp, that illuminates a light guide. For example, metal halide light sources, halogen light sources, or light emitting diodes are often used to illuminate a light guide. The light source may reside in a light source assembly (also referred to as an illuminator) having various filters and control logic. By passing the light through the filters and controlling movement of the filters with the control logic, light having an array of different colors or wavelengths can be emitted from the light source assembly. The light can be transmitted down the light guide, possibly changing colors or pulsating over time to provide the desired functional or decorative effect.

### SUMMARY

The invention is directed to techniques for bundling multiple light guides and various apparatuses and systems for implementing the techniques. For example, the cross sectional shapes of multiple light guides can be modified at the input ends of the guides to define a bundle that interfaces with a light source, or possibly another larger light guide. In some embodiments, for example, the light guides may initially have a substantially circular cross sectional shape. The shape at the input ends, however, may be modified to define ends having an elliptical, oval, pie-shaped, triangular, rectangular, trapezoidal or other shape. In this manner, the amount of light that enters the bundled light guides can be increased, resulting in the more efficient use of the light.

In addition, by removing the cladding from the light guides in a location proximate to where the respective guides are bundled, light is allowed to distribute between the multiple light guides as light transmits down the initial portion of the bundle. In this manner, light can be more readily homogenized among the light guides, enhancing the lighting effect. In particular, if the light source assembly generates light that changes colors, the invention may improve the homogeneity of color in the bundled light guides by permitting cross-coupling of light between the adjacent light guides.

In one embodiment, the invention provides a method including removing cladding material from first ends of a number of light guides. The method may also include changing the cross sectional shape of the light guides at the first ends. In another embodiment, the invention is directed to an apparatus including a number of light guides. Each of the light guides may have a first end substantially free of cladding material, and each light guide may have a cross-sectional shape at the first end that has been changed. In still another embodiment, the invention is directed towards a system. The system may include a light source assembly and a bundle of light guides coupled to the light source assembly. Again, each of the light guides may have a first end substantially free of cladding material, and each light guide may have a cross-sectional shape at the first end that has been changed.

The invention can provide several advantages. For example, by changing the cross-sectional shapes of the light guides, the amount of void area within the bundle can be controlled and/or minimized. The void area refers to the area between the adjacent light guides within a bundle. Changing the cross-sectional area of the light guides is advantageous because it allows for more efficient use of a light source. In particular, more light is coupled directly into the ends of the light guides, and less light is lost to the void areas. With the modified cross-sections, the light guides present a more continuous coupling face for the light source.

In addition, by removing the cladding material, the light guides can be bundled in a manner that allows distribution of light in that region where the cladding was removed. In particular, with the cladding removed, adjacent light guides are capable of cross-coupling light to one another via side emission. Moreover, changing the cross-sectional shapes of the light guides, combined with removing the cladding, can control and/or maximize the contact between light guides within the bundle, resulting in optical coupling efficiency. This is advantageous because it further enhances the ability of light to distribute between the light guides as it propagates down the regions where the cladding was removed. When a light source assembly implements a rotating light filter in combination with the light source, this feature can be especially advantageous, promoting the appearance of a more homogeneous and uniform light distribution among all of the light guides as the light source or filter comes into alignment with each individual light guide. Another advantage relates to manufacture and assembly of bundles of light guides, which can be simplified by the invention.

Additional details of these and other embodiments are set forth in the accompanying drawings and the description below. Other features, objects and advantages will become apparent from the description and drawings, and from the claims.

### BRIEF DESCRIPTION OF THE DRAWINGS

FIG. 1 is a flow diagram illustrating a technique for bundling multiple light guides according to an embodiment of the invention.

FIG. 2 is a cross sectional view of a bundle of two light guides according to the invention.

FIG. 3 is a side view illustrating a single light guide that may be used as part of a bundle according to the invention.

FIGS. 4 and 5 are cross-sectional views illustrating before and after cross-sectional shapes of light guides according to the invention.

FIGS. 6-8 are cross-sectional views of a bundle of light guides including three light guides.

FIG. 9 is a perspective view of a bundle of light guides according to the invention.

FIG. 10 is a cross sectional view of a bundle of light guides surrounded by a collet.

FIG. 11 is a perspective exploded view of a bundle of light guides and a collet.

FIG. 12 is a side view of a collet fitted around a bundle of light guides and a quartz rod.

FIGS. 13 and 14 are side views illustrating two exemplary systems according to the invention.

FIG. 15 is a flow diagram according to the invention.

### DETAILED DESCRIPTION

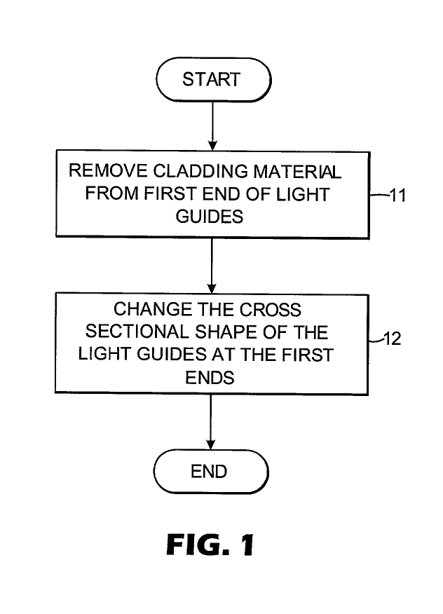

In general, the invention provides techniques for bundling multiple light guides. FIG. 1 is a flow diagram illustrating one technique. As shown, cladding is removed from the first end of a number of light guides (11). The cross sectional shapes of the light guides at the first ends are then changed (12). In this manner, a bundle of light guides having various advantages over conventional light guides can be produced.

Bundling light guides can be desirable for several reasons. For example, systems that implement light guides typically utilize a relatively expensive light source assembly to illuminate the light guides. By bundling several light guides, a single light source assembly may be used to illuminate more than one light guide at a time. This results in a more efficient and economical system. In addition, it is often desirable to illuminate several light guides in a similar fashion. Bundles can provide a relatively simple way to achieve this goal without synchronizing several light sources or light source assemblies.

In addition, it is sometimes desirable to illuminate multiple light guides at a particular distance away from the light source assembly. In this case, a bundle of light guides may be spliced to a larger light guide that interfaces with the light source assembly. In other words, bundles can provide a relative simple way to direct light from one light guide to the multiple light guides in the bundle.

Bundling light guides, however, raises several challenges. For example, a bundle of light guides may introduce significant void areas, i.e., gaps, between the individual guides. This can result in the inefficient use of the light source. Light that enters a void area typically does not propagate down a light guide, and is therefore wasted. For this reason, it is desirable to provide techniques for bundling light guides in which the amount of resultant void areas can be controlled and/or minimized.

FIG. 1 illustrates a process that can overcome this problem. By changing the cross sectional shape of the light guides at the first ends (12), the amount of resultant void areas between the light guides can be controlled. The invention is not necessarily limited in the manner in which the cross sectional shape is changed (12). Indeed, it may even depend on the original shape of the light guides and the ultimate desired shape of the bundle. Typically, however, light guides begin with a circular cross-sectional shape, and the desired shape of the bundle is a larger circular cross-section. As described in more detail below, heat, pressure, and other techniques may be utilized to change the cross sectional shape of the light guides at the first ends (12).

Another challenge that arises when light guides are bundled relates to the filtering process in light source assemblies. Filters are typically used to change the color or wavelength of light that is allowed to propagate down the light guides. Often, light source assemblies achieve the desired effects by utilizing control logic that controls the movement of filters, e.g., a color wheel, across the light source in a relatively slow manner. Thus, when light guides are bundled, a particular light guide in the bundle may see the effects of a filter much sooner than another light guide in the same bundle as a result of its orientation relative to the rotating filter. This is undesirable, however, when the desired visual effect is to simultaneously change colors in the various light guides. For this reason, it is desirable to provide techniques for bundling light guides in which light entering one light guide is allowed to distribute into other light guides, and thereby provide an appearance of more uniform color among the light guides.

FIG. 1 also illustrates a process that can overcome this conventional problem. By removing the cladding material from light guides (11), the light guides can be bundled in a manner that allows distribution of light in that region where the cladding was removed. With appropriate cross-sectional shapes, the light guides may be bundled in intimate contact with other light guides in the regions where cladding was removed. In other words, at least a portion of a lateral surface of the ends where the cladding was removed can be placed in direct contact with at least a portion of a lateral surface of one of the other ends where the cladding was removed. Thus, light that enters the bundle via a first light guide may be allowed to distribute to other light guides as it propagates down the regions where the cladding was removed because the light guides are in intimate contact. Removal of the cladding permits optical coupling via side transmission of light between adjacent light guides. In this manner, a more homogeneous visual effect may be realized. Accordingly, a combination of modified cross-sectional shapes and removal of cladding reduces or eliminates voids, and thereby promotes increased optical coupling efficiency and enhanced homogeneity of light among the light guides.

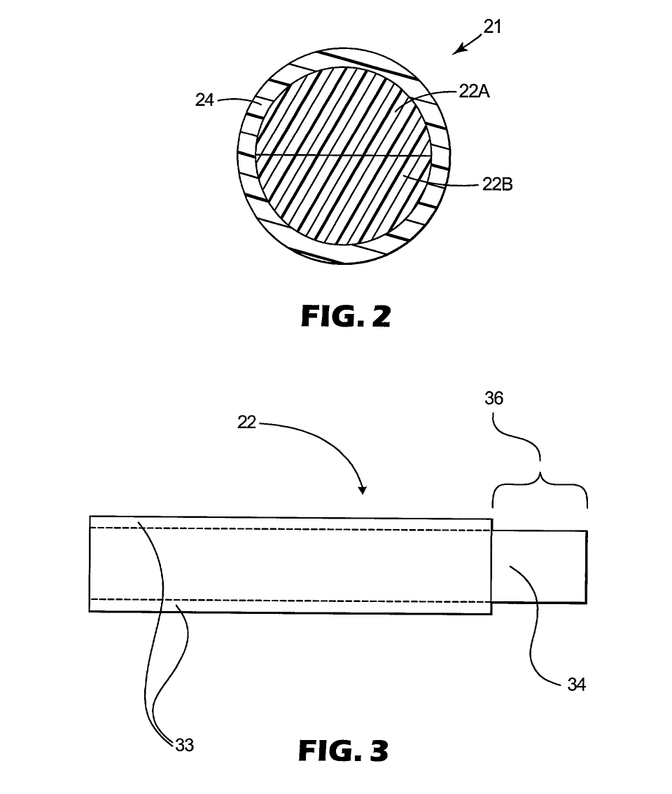

FIG. 2 is a cross sectional view of a bundle 21 of two light guides according to the invention. As shown, a first light guide 22A is bundled with a second light guide 22B. The first and second light guides 22A and 22B are surrounded by a heat shrinkable wrap 24 that serves to “bundle” the light guides. The cross-sectional shape of light guides 22A and 22B is illustrated as being half-circles, i.e., substantially hemispherical in shape. The invention, however, is not limited in that respect. Rather, the particular cross-sectional shape of the individual light guides may depend on several factors, including the original shape of the light guides, the number of light guides in the bundle, the arrangement of the light guides prior to changing the cross-sectional shape, and the method of changing the cross-sectional shape of the light guides, such as the amount of heat and pressure that is applied to the bundle.

FIG. 3 illustrates a single light guide that may be used as part of a bundle according to the invention. As shown, light guide 22 includes an outer cladding 33 and an inner core 34. The material that makes up the outer cladding 33 typically has a low index of refraction relative to that of the inner core 34. For example, outer cladding 33 may be comprised of plastic or an elastomer. More particularly, the material may be selected from the group including polyethylene, polypropylene, polyamide, polystyrene. ABS resin, polymethyl methacrylate, polycarbonate, polyvinyl chloride, polyvinylidene chloride, polyvinyl acetate, polyethylene acetate copolymer, polyvinyl alcohol, polyethylene polyvinyl alcohol copolymer, fluorocarbon resin, silicone resin, natural rubber, polyisoprene rubber, polybutadiene rubber, styrene butadiene copolymer, butyl rubber, butyl rubber halogenate, chloroprene rubber, allyl rubber, EPDM, acrylonitrile butadiene copolymer, fluoroelastomer, silicone rubber, or the like. Among others, silicone polymer and fluorocarbon polymer which have a low index of refraction relative to the core may be used. For example, a heat shrinkable flouropolymer such as fluorinated ethylene propylene (FEP), or other low refractive index heat shrink tubing can be used.

Outer cladding 33 may also include silicone polymers such as polydimethyl siloxane polymer, polymethyl phenyl siloxane polymer, fluorosilicone polymer, or the like, and/or fluorocarbon thermoplastic elastomers such as polytetrafluoroethylene(PTFE), polytetraethylene perfluoroalkoxyethylene copolymer(PFE), polycholorotrifluoroethylene(PCTFE), tetrafluoroethylene ethylene copolymer(ETFE), polyvinylidene fluoride, polyvinyl fluoride, fluorovinylidene trifluoroethylene copolymer, fluorovinylidene hexafluoropropylene copolymer, fluorovinylidene hexafluoropropylene tetrafluoroethylene terpolymer, tetrafluoroethylene propylene rubber, fluorocarbon thermoplastic elastomer, or the like. Any of these materials may be used singly or any two or more of them may be blended and used in combination to realize outer cladding 33.

The inner core 34 may be comprised of a material which can be easily deformed under heat and pressure. The inner core 34 should not be broken when deformed under pressure, and should not have a substantial change in index of refraction and loss of light transmittance when deformed under pressure. For example, the material for the inner core 34 may be selected from the group including alkyl acrylates such as methyl acylate, methyl methacrylate, or the like. Acryl polymers may also be used, such as those derived by copolymerization of alkyl acrylates or methacrylates. Other gel-state or rubber-state materials, such as silicone gel may also be used.

A protective sheath or jacket (not shown) may cover the outer cladding 33. The sheath may be made of a plastic, an elastomer, or the like. More specifically, the material may be selected from the group including high polymers such as polyamide, epoxy resin, polyvinyl chloride, polycarbonate, polystyrene, fluorocarbon resin, butyl rubber, butyl rubber halogenate, polyethylene, polypropylene, polyurethane, hydrochlorinated rubber, natural rubber, polyisoprene rubber, polybutadiene rubber, chloroprene rubber, acryl rubber, EPDM, fluoroelastomer, or the like. The sheath may be added to light guide 22 by coating, extrusion molding, taping, heat contraction or any other suitable means. A protective sleeve (not shown) could be added for mechanical stability as well. For example, the protective sleeve could be made of metal, glass, an inorganic substance or the like.

In accordance with the invention, outer cladding 33 may be removed from a first end of the light guide 22. Thus, as shown, a portion 36 of light guide 22 includes only the inner core 34. As described in more detail below, this portion 36 can be placed in intimate contact with similar portions of other light guides. In other words, at least a portion of a lateral surface of portion 36 of a first light guide may be in direct contact with a similar portion of a second light guide. A bundle of light guides can be created, wherein the cross-sectional shapes of the individual light guides is changed in the portions where the cladding was removed. Thus, the cross-sectional shape of the remainder of each light guide may be substantially unchanged.

The amount of cladding removed from portion 36 may depend on the particular application. Typically, however, less than 6 inches of cladding is removed. In other embodiments, portion 36 can be realized during fabrication of the light guides. In other words, light guide 22 may be fabricated to include a portion 36 having no cladding. In that case, the cladding does not need to be removed. Thus, a method according to the invention may include providing light guides having no cladding at first ends of the light guides, and changing the cross-sectional shape of the light guides at the first ends.

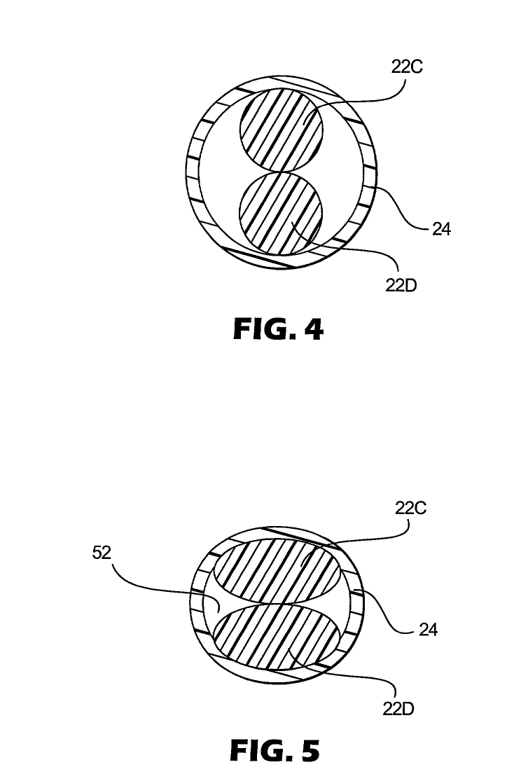

FIGS. 4 and 5 are cross-sectional views illustrating the before and after cross-sectional shapes of light guides 22C and 22D according to the invention. As shown in FIG. 4, light guides 22C and 22D may be surrounded by a heat shrinkable wrap 24. The light guides 22C and 22D do not have cladding in the areas surrounded by heat shrinkable wrap 24. In other words, the portion 36 (FIG. 3) may correspond to the regions of light guides 22C and 22D that are surrounded by heat shrinkable wrap 24. For example, heat shrinkable wrap 24 may be a relatively low refractive index heat shrinkable tubing such as a flouropolymer heat shrinkable tubing. Fluorinated ethylene propylene (FEP) tubing or modified polyvinyliclane fluoride heat shrinkable tubing sold under the trade name Kynar tubing (available from Minnesota Mining and Manufacturing Company of Saint Paul, Minn.) could be used as well. In addition, fluoroplastics or polyolefins could be used to realize heat shrinkable wrap 24. The heat shrinkable wrap 24 may have a low refractive index relative to the cores of light guides 22C and 22D. In addition, the glass transition temperature of the heat shrinkable wrap 24 may be greater than that of the cores of light guides 22C and 22D.

As illustrated in FIG. 5, the cross-sectional shape of the light guides 22C and 22D has been changed. The cross-sectional area of the light guides 22C and 22D may or may not be the same as their cross-sectional areas in FIG. 4. The shapes, however, are different. Changing the cross-sectional shape of light guides 22C and 22D provides several advantages. For example, the amount of void area, i.e. the size of gap 52, may be controlled and/or minimized. This can promote more efficient use of a light source. Moreover, the contact area between the light guides 22C and 22D may be controlled and/or maximized. This can result in more homogenious lighting effect between the light guides 22C and 22D as a result of more effective cross-coupling via side transmission between the light guides.

In addition, changing the cross-sectional shapes of the light guides can reduce or eliminate what is referred to as inactive area in the cross-sectional shape of the light guides. For example, in some conventional bundles, light from the light source may not enter part of the cross-sectional surface area of the light guides. The regions where light does not enter are referred to as inactive area of a cross-sectional surface of the light guides. By changing the cross-sectional shapes of the light guides, this inactive area can be reduced or eliminated, resulting in the more efficient use of the light source and an enhanced visual effect from the light guides.

One method of changing the cross-sectional shapes of the light guides involves the use of heat and pressure. For example, the light guides 22C and 22D along with heat shrinkable wrap 24 may be heated. Pressure can then be applied to the bundle to change the shapes of the light guides in the regions surrounded by the heat shrinkable wrap 24. In this manner, the cross-sectional shape of the ends of light guides 22C and 22D may be changed. Indeed, if enough heat and pressure is applied, the light guides 22C and 22D may become thermally bonded to one another. As more and more heat and pressure is applied, the cross-sectional shapes of light guides 22C and 22D may look more and more like the shapes illustrated in FIG. 2.

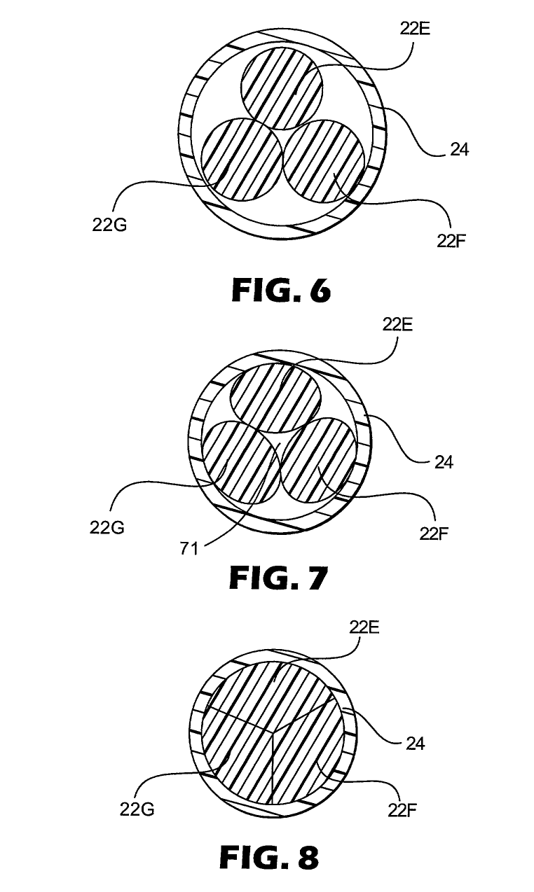

Any number of light guides may be included within a bundle. For example, FIGS. 6-8 are cross-sectional views illustrating the use of three light guides 22E, 22F and 22G. These three light guides 22E, 22F and 22G, along with heat shrinkable wrap 24 may be heated. Pressure can then be applied to the bundle to change the shapes of the light guides in the regions surrounded by the heat shrinkable wrap 24. In this manner, the cross-sectional shape of the ends of light guides 22E, 22F and 22G may be changed. As more and more heat and pressure is applied, the cross-sectional shapes of light guides 22E, 22F and 22G may look more and more like the shapes illustrated in FIG. 8.

When more than two light guides make up a bundle, a center void area 71 in the center of the light guides may be present. This center void area 71, however may be particularly disadvantageous because a light source, to which the bundle may be coupled, often generates the strongest light near this center region. Thus, in accordance with the invention, heat and pressure may be applied to a degree sufficient to substantially reduce or eliminate the center void area completely.

Bundles of light guides according to the invention provide several advantages. For example, by changing the cross-sectional shapes of the light guides, the amount of void area within the bundle can be controlled and/or minimized. This is advantageous because it allows for the more efficient use of a light source. Light that enters the void areas generally does not propagate down the light guides. Thus, by minimizing the size of the void areas, the light source can be utilized more efficiently. In particular, more efficient use of the light source can be achieved by reducing or eliminating center void areas as described above.

In addition, changing the cross-sectional shapes of the light guides can control and/or maximize the contact between light guides within the bundle. This is advantageous because it further enhances the ability of light to distribute between the light guides as it propagates down the regions where the cladding was removed. In this manner, a more homogenous visual effect can be realized when a light source assembly illuminating the bundle changes colors over time.

Another advantage relates to manufacturing and assembly. Light guides are generally fabricated to have a tubular shape. By changing the cross-sectional shapes of the light guides at ends of light guides, the need for pre-molded light guides can be avoided. In other words, although light guides could be pre-molded to have dimensions corresponding to the various illustrations of FIG. 2, FIG. 5, FIG. 7 and FIG. 8, pre-molded light guides could be much more difficult and costly to realize. In contrast, bundles of light guides according to the invention may be more easily fabricated using existing tubular shaped light guides with changed cross sectional surfaces at first ends. Indeed, bundles can even be fabricated to retrofit a particular light source assembly.

In addition, bundles of light guides according to the invention may reduce or eliminate the need for relatively costly couplers, splitters or multi-legged harnesses which are spliced to multiple light guides. In accordance with the invention, bundles of light guides may be realized without a coupler, splitter or multi-legged harness, possibly reducing the number of splices in the apparatus. Indeed, reducing the number of splices in the apparatus can avoid the loss of light from the light guides at the splice. While there are optical losses along the longitudinal splices that form during the deformation process, those losses may be less than or comparable to the combined optical loss from multiple splices between a coupler and individual light guides.

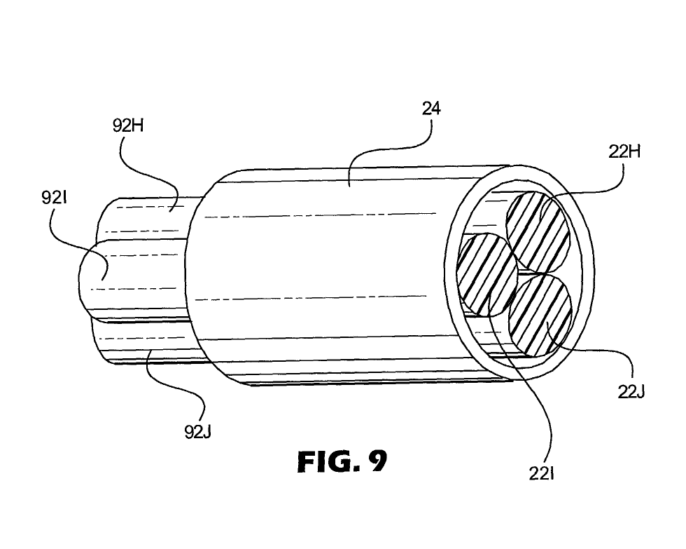

FIG. 9 is a perspective view of a bundle of light guides according to the invention. As shown, three light guides 22H, 22I and 22J are surrounded by heat shrinkable wrap 24. The heat shrinkable wrap surrounds the light guides 22H, 22I and 22J at first ends of the light guides that have no cladding. Second ends 92F, 92G and 92H of light guides 22H, 22I and 22J may have cladding. The cross-sectional shape of first ends of light guides 22H, 22I and 22J may be changed as described herein.

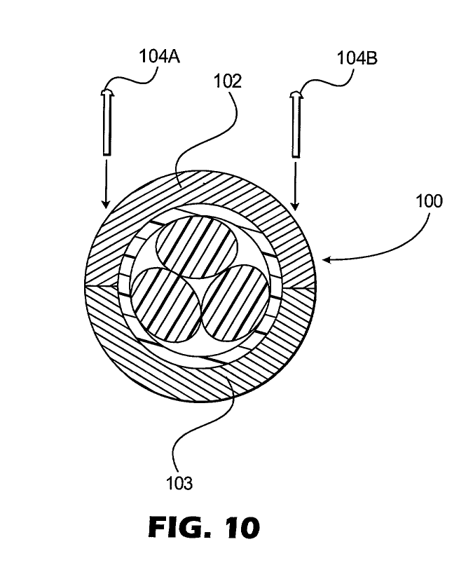

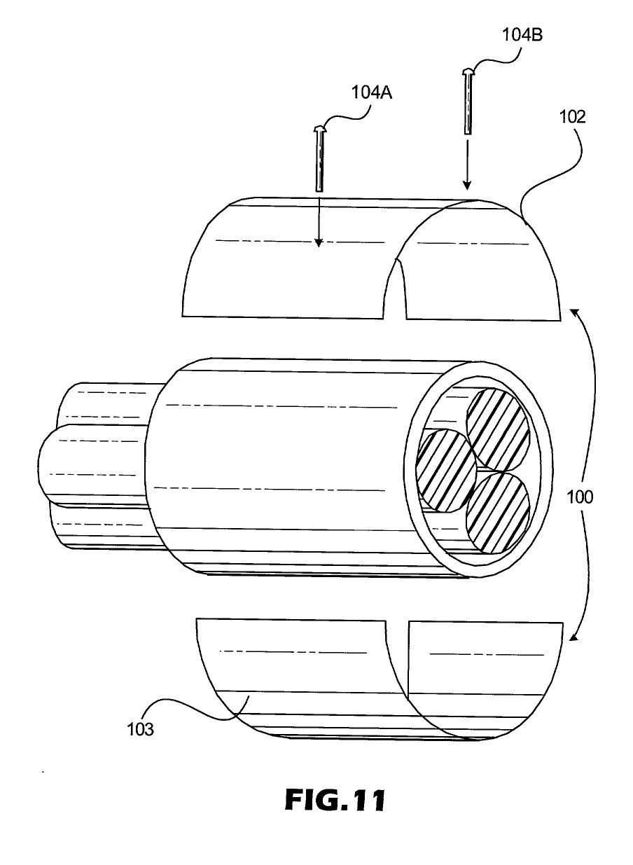

FIG. 10 is a cross sectional view of a bundle of light guides surrounded by a collet. FIG. 11 is a perspective exploded view. Collet 100 may have an upper collet portion 102 and a lower collet portion 103 attached by attachment devices such as screws 104A and 104B. Alternatively, bolts, clamps, threaded rings, or the like, may be used. Collet 100 may be sized to fit into a light source, thus improving the interface between the bundle of light guides and the light source. For example, collet 100 may be comprised of a substantially rigid material, such as metal, and may be thermally conductive so that heat can be transferred to the bundle of light guides through collet 100 during the bundling process.

In one embodiment, collet 100 is used in the process of changing the cross sectional shape of the light guides. For example, heat may be applied to the bundle through collet 100. Pressure may be applied to the bundle by tightening the attachment devices.

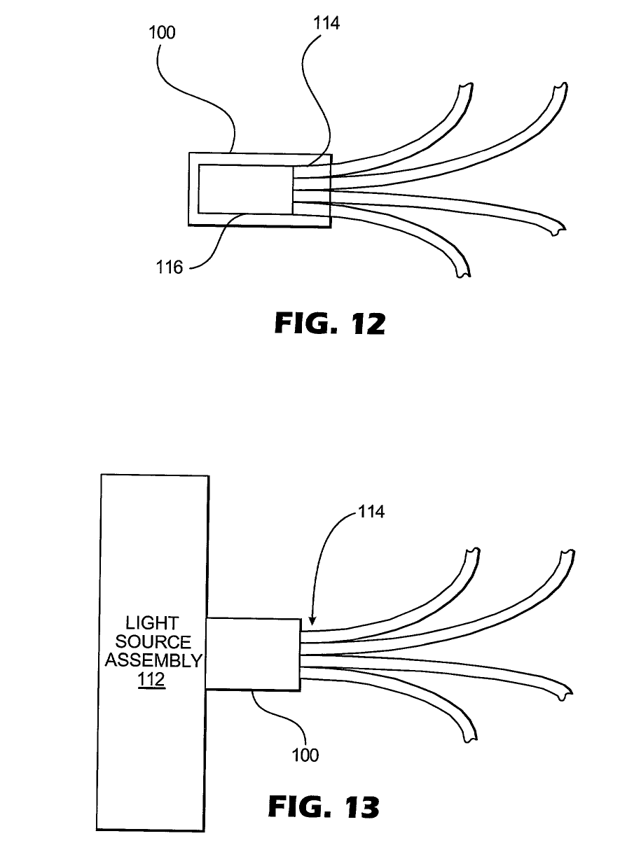

FIG. 12 illustrates another embodiment, wherein a collet 100 is fitted around a bundle of light guides 114 and a quartz rod 116, or other suitable optically transmissive medium such as inorganic glass. The quartz rod 116 provides an optical interface that can be illuminated by the light source. The bundle of light guides 114 may be butted against the quartz rod 116, and an additional layer of heat shrinkable wrapping (not shown) may be shrunk around the quartz rod 116 and the bundle of light guides 114. Collet 100 may then be attached around the quartz rod 116 and subsequently inserted into a light source assembly.

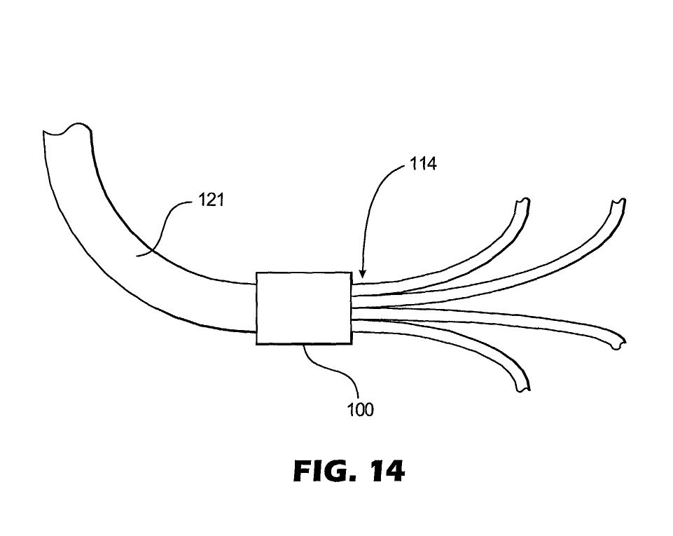

FIGS. 13 and 14 illustrate two exemplary systems according to the invention. For example, FIG. 13 illustrates a light source assembly 112 coupled to a bundle of light guides 114. The light source assembly may include a light source such as a metal halide light source, a halogen light source, a light emitting diode, or the like. Moreover, the light source assembly may include various filters and control logic for creating the desired lighting effect through the bundle of light guides 114. The bundle of light guides 114 may include one or more of the features described above, such as light guides having cladding removed, light guides having changed cross sectional shapes and/or heat shrinkable wrapping. In addition, a collet 100 may surround the bundle of light guides 114 and a quartz rod (not shown) can be butted against the bundle of light guides 114.

In the system of FIG. 14, the bundle of light guides 114 are attached to a larger light guide 121. In this system, the bundle of light guides may propagate light in either direction. In other words, light may propagate through the larger light guide 121 and then be distributed to the multiple light guides in the bundle 114. Alternatively, light may propagate in the other direction, through the multiple light guides in the bundle and then down the larger light guide 121. A heat shrinkable wrapping (not shown) may be used to hold the multiple light guides in the bundle 114 to the larger light guide 121. The wrapping may be clear. Other methods of forming a splice between the larger light guide 121 and the bundle 114 may be used as well. In addition, a protective sleeve (not shown) may surround the bundle 114 and the larger light guide 121.

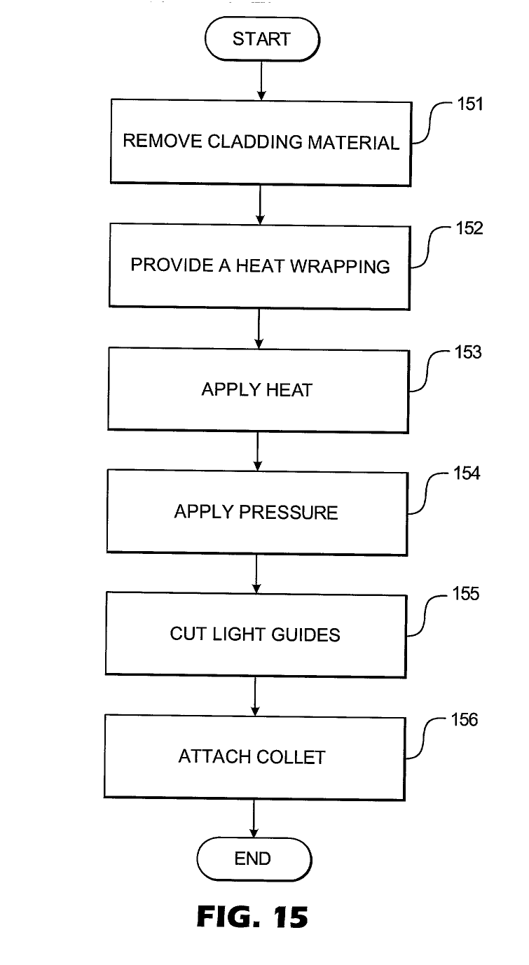

FIG. 15 is a flow diagram illustrating in greater detail, a technique for realizing a bundle of light guides according to the invention. As shown, cladding material is removed from a number of light guides (131). A heat wrapping is provided around the light guides in the region where the cladding was removed (132). Heat and pressure is then applied (133 and 134). The heat can shrink the wrapping and soften the light guides. The amount of heat that is applied depends on the materials used. For example, the temperature during deformation should be less than the temperature at which the materials will decay, but greater than the glass transition temperature of the material. Approximately 20 degrees Celsius to 200 degrees Celsius above the glass transition temperature may be suitable.

Pressure can be applied to change the cross sectional shape of the light guides (134). Like the amount of heat used, the amount of pressure may depend on the type of material used. Moreover, as more heat is applied, less pressure may be needed to change the cross sectional shape of the light guides. The pressure may be applied through the use of a mold, a collet, a clamp, a pair of pliers, a vice grip, or the like. In some embodiments, the heat and pressure cause the light guides to become thermally bonded to one another. Additional heat may be supplied to further shrink the heat shrinkable wrapping after applying the pressure. Indeed, the heat shrinkable wrapping may constrain the light guides so that they do not change back to their original shape when they cool.

In one embodiment, the pressure is applied through the use of a specially machined molding tool. The molding tool may change the cross sectional shape of the light guides according to a predetermined shape machined into the molding tool. Any shape, including pie shapes, half circular shapes, or more complex geometric shapes could be machined into the molding tool. Indeed, the desired shape may depend on the number of light guides that are being ultimately bundled. Once, first ends of the light guides have been molded, the first ends may be placed in intimate contact, and a heat shrinkable tubing can be used to hold the first ends together, thereby defining the bundle.

The light guides can then be cut (135) after the light guides have cooled so that the ends of the light guides define a plane. Finally, a collet can be attached around the light guides (136). Moreover, attaching the collet may include applying additional heat through the collet and/or applying additional pressure by tightening the collet around the light guides. Additionally, a quartz rod, or the like, can be butted against the cut ends of the light guides prior to attaching the collet. In this manner, a bundle of light guides according to the invention can be easily fabricated from light guides having any particular shape, such as conventional tubular shaped light guides.

Alternatively, the bundle of light guides may be butted against a larger diameter light guide. Additional layers of heat shrinkable tubing may be used to form a splice between the bundle and the larger diameter light guide. The splice may be further reinforced with still additional layers of tubing or a plastic or metal sleeve.

### EXAMPLE 1

Approximately 10 centimeters of cladding was removed from the ends of two light guides having 9 millimeter diameters (LF90HL light fibers available from Minnesota Mining and Manufacturing Company, of Saint Paul, Minn.). The ends were inserted into a flouropolyrner heat shrinkable tubing approximately 14 centimeters in length. Heat was applied until the light guides became pliable and the tubing began to shrink around the light guides. The two ends were then squeezed together with a pistol jaw type C-clamp. The continued application of heat caused the flouropolymer heat shrinkable tubing to continue to shrink around the light guides. The light guides, now having a changed cross sectional surface shape at the two ends that were squeezed, were slid into a metal collet having an inner diameter of approximately 13.9 millimeters (a SolarTec CL metal collet available from Cogent of Santa Clarita, Calif.). After the flouropolymer heat shrinkable tubing and light guides cooled, they were removed from the collet and the light guides were cut so that the ends of the light guides defined a substantially planar surface. The light guides were then reasserted into the collet.

The bundle of light guides were then inserted into a 150 Watt metal halide illuminator (available from Laser Media of Los Angles, Calif.). Light launched into the light guides was substantially uniform. The cross sectional shape of the light guides were changed at the ends that were squeezed such that approximately half of the cross sectional area of the inside of the collet was filled by each light guide. The shapes of the light guides were not perfectly symmetric.

Lumens of output of the different light guides at different orientations were measured by rotating the bundle of light guides within the port of the illuminator. The efficiency of the bundle was compared to an equal length of 12 mm HL light fiber (available from Minnesota Mining and Manufacturing Company of Saint Paul, Minn.). The coupling efficiency was approximately 28%. The relatively low efficiency, however, was due in part to the increased circumferential area through which the light was intentionally ejected to create a strong side-glow effect. Approximately 70% of the inlet aperture of the collet was filled with core material.

The absolute number of lumens measured in the two different light guides at six different orientations were also recorded for comparison with one another. The mean number of lumens for the first light guide at a location approximately 19.5 centimeters down the guide from the light source was 286 lumens with a standard deviation of 13 lumens. The mean number of lumens for the second light guide at a location approximately 19.5 centimeters down the guide from the light source was 295 lumens with a standard deviation of 10 lumens.

### EXAMPLE 2

A two-part collet was designed. The collet had a first end with a 13.9 millimeter inner diameter and a 15.9 millimeter outer diameter. The other portion of the collet was machined so that the inner diameter expanded from approximately 13.9 millimeters to 21.5 millimeters. The collet was approximately 4.9 centimeters long.

Approximately 5 centimeters of cladding was removed from three light guides having 7 millimeter diameters (LF70 light fibers available from Minnesota Mining and Manufacturing Company of Saint Paul, Minn.). The ends, with the cladding removed, were inserted into a sleeve of flouropolymer heat shrinkable tubing and heated. When the flouropolymer heat shrinkable tubing was in close contact with the light guides, the light guides were placed inside the metal two-part collet. The screws of the collet were tightened and heat was applied via a heat gun. After the screws were tightened completely, the assembly was allowed to cool and the ends of the fibers were trimmed to create a uniform plane at the end of the collet. The collet was then attached to a light source assembly having a 150 Watt metal halide light source.

The length of the three different light guides was approximately 30 centimeters, with a variation of approximately 2 centimeters. The light output of the three different light guides in the bundle were measured at four different orientations in the illuminator. The mean number of lumens for the first light guide was 548 lumens with a standard deviation of 21 lumens. The mean number of lumens for the second light guide was 595 lumens with a standard deviation of 27 lumens. The mean number of lumens for the third light guide was 599 lumens with a standard deviation of 20 lumens. The mean total number of lumens for the three light guides was 1743 lumens with a standard deviation of 13 lumens. This was compared to the lumen flux through a 30 centimeter piece of LF120 light fiber (available from Minnesota Mining and Manufacturing Company of Saint Paul, Minn.) to calculate an efficiency of approximately 68%.

### EXAMPLE 3

Approximately 4 centimeters of cladding was removed from two ends of a 9 millimeter diameter light guide (LF90HL light fiber available from Minnesota Mining and Manufacturing Company of Saint Paul, Minn.). The ends with the cladding removed were inserted into a sleeve of flouropolymer heat shrinkable tubing and heated. When the flouropolymer was in close contact with the light guides, the light guides were placed inside a metal two-part collet, like that described in EXAMPLE 2. The screws of the collet were tightened and heat was applied via a heat gun. After the screws were completely tight, the assembly was allowed to cool and the ends of the fibers were trimmed to create a uniform plane at the end of the collet. The collet was then attached to a 150 Watt metal halide illuminator (available from Laser Media of Los Angles, Calif.).

The luminance along the light guide was measured and compared to a single 9 millimeter light guide end placed at the center of the port of the same illuminator. The cumulative luminance along the length of the dual-ended bundle was only about 18% lower than the luminance measured for the single light guide. The bundle maintained good color consistency form both ends over the entire length of approximately 16 meters. In this case, a 13 millimeter illuminator port was used to direct light into both ends of a 9 millimeter diameter light guide.

A number of implementations and embodiments of the invention have been described. For instance, techniques for bundling multiple light guides have been described. Nevertheless, it is understood that various modifications can be made without departing from the spirit and scope of the invention. For example the light guides may have original cross sectional dimensions of any shape or size. Accordingly, other implementations and embodiments are within the scope of the following claims.

1. A method comprising:
removing cladding material from first ends of a number of light guides, and
changing the cross sectional shape of the light guides at the first ends.

2. The method of claim 1, further comprising bundling the number of light guides such that at least a portion of a lateral surface of the first end of each of the light guides is in direct contact with at least a portion of a lateral surface of the first end of at least one other light guide.

3. The method of claim 2, further comprising bonding the bundled light guides to one another.

4. The method of claim 2, wherein bundling the number of light guides includes heating a relatively low refractive index wrapping around the number of light guides.

5. The method of claim 4, wherein heating the relatively low refractive index wrapping comprises heating a heat shrinkable tubing.

6. The method of claim 1, wherein changing the cross sectional shape of the light guides includes heating the light guides and applying pressure to the light guides.

7. The method of claim 6, wherein applying pressure to the light guides includes tightening a collet around the light guides.

8. The method of claim 6, wherein applying pressure to the light guides includes tightening a mold around the first end of each light guide, the mold defining a desired cross sectional shape for each light guide.

9. The method of claim 8, further comprising removing the mold and bundling the light guides by inserting the first ends into a heat shrinkable tubing and shrinking the tubing around the first ends.

10. The method of claim 7, wherein heating the light guides includes applying heat to the light guides through the collet.

11. The method of claim 1, further comprising wrapping the light guides in a heat shrinkable wrapping material.

12. The method of claim 1, further comprising coupling the light guides to a single light source assembly.

13. The method of claim 1, further comprising changing the cross sectional shape of the light guides at the first ends to a degree sufficient to substantially reduce void areas between the light guides.

14. An apparatus comprising:
a number of light guides forming a bundle, each of the light guides having a first end substantially free of cladding material, wherein each light guide has a cross sectional shape at the first end that has been changed.

15. The apparatus of claim 14, wherein each light guide has a cross sectional shape at the first end that has been changed by a process of applying heat and pressure to the bundle.

16. The apparatus of claim 14, wherein portions of the light guides disposed away from the first ends have substantially circular cross sectional shapes.

17. The apparatus of claim 14, wherein the first ends are bonded together.

18. The apparatus of claim 14, further comprising a collet surrounding the first ends.

19. The apparatus of claim 14, further comprising a heat shrinkable wrapping surrounding the first ends.

20. The apparatus of claim 19, further comprising a collet surrounding the heat shrinkable wrapping.

21. The apparatus of claim 19, wherein the heat shrinkable wrapping is comprised of material selected from the group consisting of flouroelastomers, fluoroplastics, and polyolefins.

22. The apparatus of claim 19, wherein the heat shrinkable wrapping is a tubing.

23. The apparatus of claim 19, wherein the heat shrinkable wrapping has a low refractive index relative to that of cores of the light guides.

24. The apparatus of claim 14, wherein second ends of the light guides have cladding material.

25. A lighting system comprising:
a light source assembly, and
a bundle of light guides coupled to the light source assembly, each of the light guides having a first end substantially free of cladding material, wherein each light guide has a cross sectional shape at the first end that has been changed.

26. The lighting system of claim 25, wherein each light guide has a cross sectional shape at the first end that has been changed by a process of applying heat and pressure to the bundle.

27. The system of claim 25, wherein portions of the light guides disposed away from the first ends have a substantially circular cross sectional shapes.

28. The system of claim 25, wherein the first ends are thermally bonded to one another.

29. The system of claim 25, further comprising a heat shrinkable wrapping surrounding the first ends.

30. The system of claim 25, further comprising a quartz rod butted against the first ends.

31. The system of claim 10, further comprising a heat shrink wrapping surrounding the first ends and the quartz rod.

32. The system of claim 30, further comprising a collet surrounding the heat shrink wrapping, the collet coupling the light guides to the light source assembly.

33. The system of claim 25, wherein second ends of the light guides have cladding material.

34. The system of claim 25, wherein the light source assembly includes a light source selected from the group consisting of: a metal halide light, a halogen light and a light emitting diode.

35. The system of claim 25, wherein the light source assembly includes control logic for controlling the light emitted from the light source assembly.

36. The system of claim 25, wherein the light source assembly includes light filters.

37. An apparatus comprising:
a number of light guiding means for guiding light, each of the light guiding means having a first end substantially free of cladding material, wherein the first ends have cross sectional shapes that have been changed.

38. The apparatus of claim 37, wherein the first ends have cross sectional shapes that have been changed by a process of applying heat and pressure to the number of light guiding means.

39. A method comprising:
providing a number of light guides having first ends that include no cladding material, and
changing the cross sectional shape of the light guides at the first ends.

40. The method of claim 39, further comprising bundling the number of light guides such that at least a portion of the lateral surface of the first end of each of the light guides is in direct contact with at least a portion of a lateral surface of the first end of at least one other light guide.

41. A method comprising:
removing cladding material from first ends of a number of tubular shaped light guides,
surrounding the first ends with a heat shrinkable wrapping material,
applying heat and pressure to the first ends to change the cross sectional shape of the light guides at the first ends, and
attaching a collet around the first ends.

42. An apparatus comprising:
a first light guide having a first end substantially free of cladding material;
a second light guide disposed adjacent the first light guide and having a first end substantially free of cladding material;
a wrapping surrounding the first and second light guides at the first ends.

43. The apparatus of claim 42, wherein second ends of the first and second light guides include cladding material.

44. An apparatus comprising:
a number of light guides having first ends substantially free of cladding material and second ends including cladding material, wherein at least a portion of a lateral surface of the first end of each of the light guides is in direct contact with at least a portion of a lateral surface of the first end of at least one other light guides.

45. The apparatus of claim 44, further comprising a heat shrinkable wrapping surrounding the light guides at the first ends.

46. The apparatus of claim 44, further comprising a larger light guide butted against the number of light guides at the first ends.

47. The apparatus of claim 46, further comprising a heat shrinkable wrapping surrounding the number of light guides at the first ends and the larger light guide.

48. The apparatus of claim 47, further comprising a protective sleeve surrounding the heat shrinkable wrapping.
